(19) United States
(12) Patent Application Publication
(10) Pub. No.: US 2006/0268417 A1
(43) Pub. Date: Nov. 30, 2006

(54) A Refractive Scheme for Dual Lamp High Brightness Projection System

(75) Inventors: Steven M. Penn, Plano, TX (US); Anupama K. Iyengar, Garland, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 10/908,854

(22) Filed: May 27, 2005

(51) Int. Cl. G02B 27/10

(52) U.S. Cl. 359/618

(57) ABSTRACT

Described is an optical device for combining multiple light sources in an optical projection system. One embodiment of the optical device includes having at least two light sources entering an aperture and being substantially aligned by a light refraction element. The substantially aligned beams of light are combined and confined within a housing element and become substantially homogenized mixed light.

### TECHNICAL FIELD

Disclosed embodiments relate to optical projection systems, and more particularly to an optical device for homogenizing multiple light sources.

### BACKGROUND

Many types of optical projection systems have been developed that use an illumination source to project an image. These optical projection systems are capable of providing high resolution and high contrast images having an excellent color gamut. One of the key criteria that distinguish various projection systems is the brightness of the image. High image brightness is an important differentiating factor in the marketplace. High projector flux output enables high image brightness, which enables viewers to clearly see the projected image, even in venues having a high ambient light level, and enables projection of very large images.

The brightness of a projected image is limited by the light source luminance (lumens per emitting area per solid angle). High output flux levels are especially difficult to achieve with optical devices that have a relatively small area because they in turn require use of light sources having very small etendue or area-solid angle product.

Xenon and metal halide arc lamps are light sources with very high luminance, but may be unacceptable for many projection system applications because of the short lifetimes (generally less than 2000 hours), high power requirements, and safety concerns. A few arc lamps, such as high-pressure mercury lamps, have longer lifetimes (between 6000 and 8000 hours) and a smaller etendue, but do not provide a high total flux. One technique that may be used to increase the brightness of a projected image is to use larger light sources, but larger lamps mean greater arc or larger etendue, which does not efficiently couple to smaller area optical components such as digital micromirror devices (DMDs). Another technique involves combining multiple light beams from multiple lamps within an integrating rod, as disclosed in U.S. Pat. No. 6,545,814 to Bartlett et al. However, orientation of the lamps not only physically increase the size of the package, the lamps are also tilt-sensitive because of fundamental arc electrode limitations thereby constraining efficient operation to one fixed orientation.

### SUMMARY

Described are optical devices for homogenizing multiple light sources for an optical projection system. The disclosed optical devices are operable to homogenize multiple light sources with minimum package dimension and with the freedom from light source orientation constraints. The disclosed optical devices further disclose small etendue to enable efficient coupling to DMDs. One embodiment of the optical device includes at least two light sources having first and second optic axes and a light refraction element for substantially aligning the first and second optic axes of the two light with each other. In another embodiment, an aperture may be located between the at least two light sources and the light refraction element wherein the aperture substantially reflects the at least two light sources and the light source's reflectors substantially recollects the rejected light. In yet another embodiment, the at least two lights are substantially combined and confined within a housing that may be solid, hollow, or partially solid and partially hollow.

### BRIEF DESCRIPTION OF THE DRAWINGS

FIG. 1 is a block diagram of an optical projection system;

FIG. 2 is an optical device of the presently disclosed embodiment;

FIG. 3 illustrates the various light refraction elements that may be used with the presently disclosed embodiment;

FIG. 4 illustrates the interactions of the beams of light with a light refraction element of the presently disclosed embodiment; and

FIG. 5 illustrates the interactions of the beams of light within a housing of the presently disclosed embodiment.

### DETAILED DESCRIPTION OF THE PREFERRED EMBODIMENTS

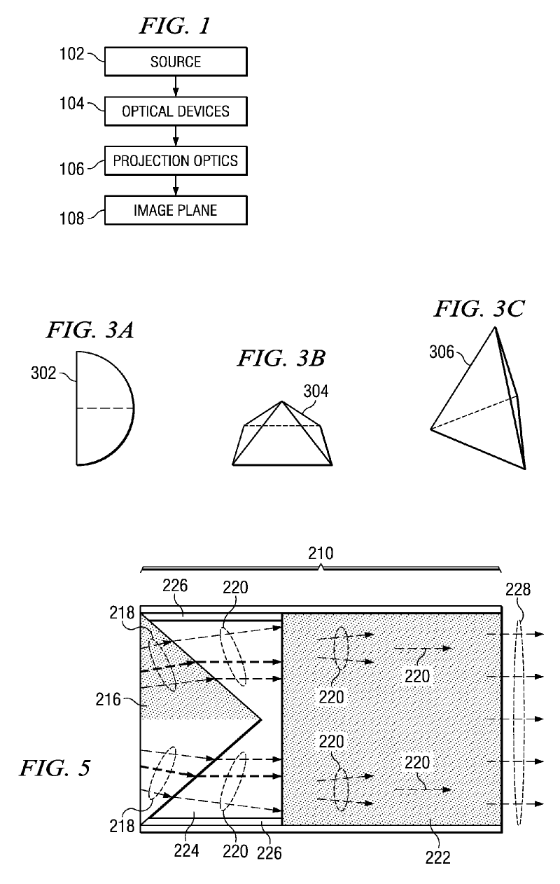

FIG. 1 is a block diagram of the various devices and components of an optical projection system generally starting with a light source 102, such as a mercury arc lamp. Xenon or metal halide arc lamps may also be used. Alternatively, solid-state light sources 102 such as laser diodes or light emitting diodes may also be used. Beams of light from the light sources 102 are then processed by optical devices 104, including but not limited to color separation elements such as color filters and color wheels, optics such as condensing lenses and shaping lenses, or integrating elements such as an integrating rod. These optical devices 104 may substantially align, shape, configure, filter, or orient the beams of light. In addition, optical devices 104 may also include a digital light processing (DLP) unit including a processor with memories and a digital micromirror device (DMD). Also included are modulators and controllers for receiving and modulating substantially aligned beams of light. After the light beams have been substantially aligned and modulated, they are focused by projection optics 106 and projected onto an image plane 108 such as a TV or movie screen.

The presently disclosed embodiment combines multiple light sources 102 along with optical devices 104, thereby allowing an optical projection system to meet the lumens high brightness requirement.

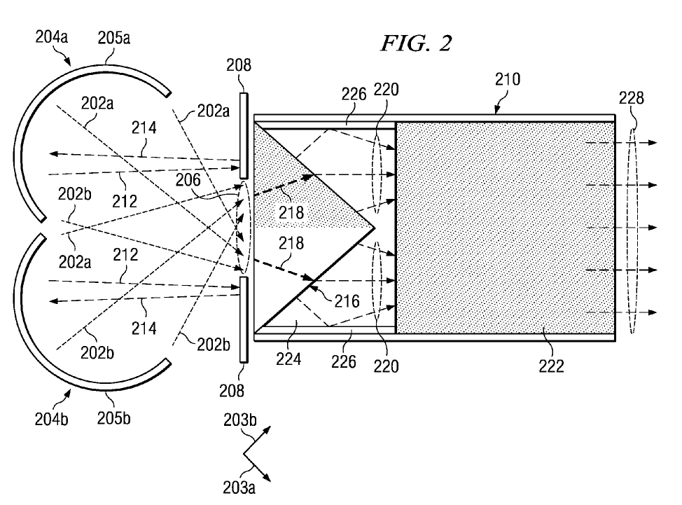

In general, FIG. 2 is an optical device or system that couples light beams 202 from two light sources 204 into a housing 210 for increased efficiency. In a specific embodiment, the light sources 204 are two f/1 elliptical-reflector-based 250 W lamps oriented at 35°, the housing 210 is a 0.95-inch integrating rod at f/2.2, and the increased gain in efficiency is 60% greater than a single lamp setup. Additionally, although only two light sources 204 are illustrated, in other embodiments three, four or more light sources 204 may be used.

As illustrated, light beams 202 from the two light sources 204 and their respective reflectors 205 are projected toward a housing 210 through an aperture 208 at their own respective optic axes 203. For example, the optic axis of the light beam 202a from the top light source 204a passes through the aperture 208 substantially along a first direction 203a, while the optic axis of the light beam 202b from the bottom light source 204b passes through the aperture 208 substantially along a second direction 203b. Most of the light 202 that is projected toward the aperture 208 passes through an opening 206 on the aperture 208. In one embodiment, each light source reflector 205 has a diameter of about 40 mm, while the aperture opening 206 is about 10 mm. The aperture 208 also reflects light beams 214 back into the light source reflectors 205, which then reflect the light beams 212 back again toward the aperture 208. The aperture opening 206 then passes at least some of these reflected light beams 212 from the light source reflectors 205. Although the aperture 208 appears to be detached from the housing 210, the two may be formed from a single unit. The aperture 208 may also be a separate unit masked or formed over the housing 210. Additionally, the aperture 208 may also be placed very close to, or on the same plane as the housing's 210 input face. In another embodiment, an aperture 208 may not be necessary, and the light beams 202 from the two light source reflectors 205 may be focused directly into the housing 210 without any loss of light.

After passing through the aperture opening 206, the light beams 202 are transmitted through a light refraction element 216 such as a prism within the housing 210. The prism 216 may also be positioned outside of the housing 210. Although the light beams 202 are illustrated as being focused on the aperture opening 206, the light beams 202 from the two light source reflectors 205 may also be focused at the entrance of the housing 210. In particular, the light beams 202 from the two light source reflectors 205 are focused at an input face of the prism 216. The aperture opening 206 may be larger than as shown to allow the converging ray bundles of light beams 202 to get to the input face of the prism 216. In a specific embodiment, the light refraction element 216 is a 45-45-90 prism. The beams of light 202 are once-refracted 218 when they enter the light refraction element 216 and twice refracted 220 when they exit the light refraction element 216. The twice-refracted beams of light 220 will then travel through the housing 210 and exit as homogenized light 228. In addition, the housing 210 may be solid 222 or hollow 224 with a coating 226. These and other elements described herein will be discussed in further detail.

FIG. 3 illustrates the various light refraction elements 216 that may be used with the presently disclosed embodiment. In some embodiments, the light refraction element 216 may be a lens 302, a square pyramid 304, or a triangular pyramid 306. The pyramids 304, 306 are the preferred light refraction elements 216 when three or four light sources 204 are utilized. Furthermore, the light refraction element 216 may be a polygon or an optical component with curvatures. In addition, if the light sources 204 were solid-state lasers or diodes, then the light refraction elements 216 may include wavelength-specific coatings, plates, gratings, filters, or prisms.

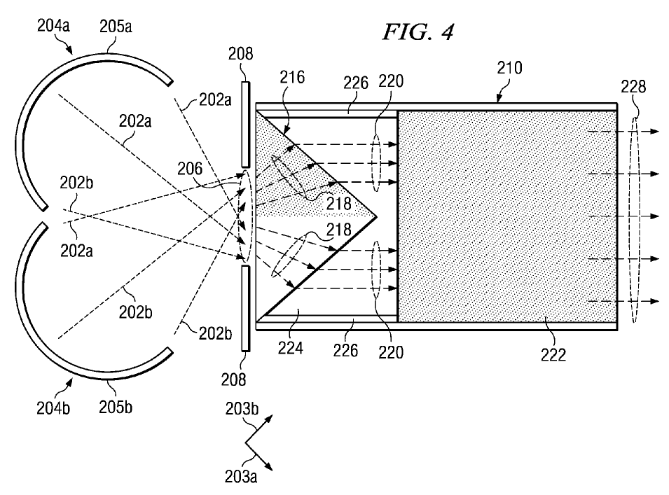

FIG. 4 more specifically illustrates the interactions of the beams of light 202 within the light refraction element 216. The prism 216 initially refracts the incoming beams of light 202 by bending them because of its optical properties such as the index of refraction. Additionally, the amount of bending and refracting may be customized based on the type of prism 216 used in the system. Furthermore, the beams of light 202 from the two light sources 204 are also substantially aligned with each other by the light refraction element 216. As previously discussed, the optic axis of the light beam 202a from the top light source 204a passes through the aperture 208 substantially along a first direction 203a, whereas the optic axis of the light beam 202b from the bottom light source 204b passes through the aperture 208 substantially along a second direction 203b. After the light beams 202 are refracted by the light refraction element 216, the optic axes of the light beams 202 are no longer directed substantially along a first or second direction but are now substantially aligned with each other. In other words, although light beams 202 initially passing through the aperture 208 are directed substantially along a first or second direction along with some divergent rays of light, when these light beams 202 encounter the light refraction element 216, their optical axes (upon exiting the light refraction element 216) of these once-refracted light beams 218 are redirected to proceed substantially in parallel (horizontally from left to right as shown in the present example figure). Subsequently, as these once-refracted light beams 218 exit the prism 216, they become twice-refracted beams of light 220 and are further substantially aligned in parallel with each other. Consequently, the light refraction element 216 not only refracts the beams of light 202, it also substantially aligns the optic axes 203 of the two light sources 204 with each other by bending or refracting the beams of light 202.

Referring now to FIG. 5, which illustrates the interactions of the twice-refracted beams of light 220 within a housing 210 of the presently disclosed embodiment. As the twice-refracted beams of light 220 are projected down the housing 210, they become substantially homogenized or blended together. In one embodiment, the housing 210 may be an integrating rod. The integrating rod 210 may be made of a solid optical glass material 222 such as BK7 or fused silica, or it may be hollow (air or vacuum) 224 and coated with an optically reflective material 226. In another embodiment, the housing 210 may be an optic fiber. Although the integrating rod 210 appears cylindrical as shown, it may take on a variety of geometric or polygonal shapes and sizes such as cones or spheres. In another embodiment, the integrating rod 210 may also be partially hollow 224 and partially solid 222. As previously mentioned, the optical axes of the twice-refracted beams 220 enter the integrating rod 210 traveling substantially in parallel to each other. But since each beam has a certain angle of divergence, each of the beams also has light that in free space would continue diverging from the main optical axes. To contain these diverging beam components and to ultimately blend them as the twice-refracted beams 220 propagate through the integrating rod 210, the diverging light energy is either reflected by an internal reflective coating 226 within the hollow 224 or partially hollow 224 integrating rod 210 or contained by total internal reflection (TIR) effects within a solid optical rod 210. The random reflections occurring over a sufficiently long integrating rod 210 ultimately cause the light exiting the rod 228 to be substantially homogenized. Consequently, the twice-refracted light beams 220 will be substantially combined and confined by the housing 210 and become uniformly blended as homogenized mixed light 228 whether the integrating rod 210 is solid or hollow.

A modulator (not shown) may then be configured in the optical projection system to receive the substantially homogenized and aligned mixed light beams 228. The mixed light beams 228 are subsequently modulated by the modulator, transmitted to a projection lens (not shown), and eventually onto an image plane (not shown). Additionally, the mixed light beams 228 may also be processed by a DMD on a digital light projection (DLP) board before being transmitted to a projection lens. The features and functions of spatial light modulators (SLMs) and DMDs are further described in a commonly owned U.S. Pat. No. 6,643,069 entitled “SLM-based color projection display having multiple SLM's and multiple projection lenses,” Ser. No. 09/940,978, filed Aug. 28, 2001, which is incorporated herein by reference in its entirety for all purposes.

It will be appreciated by those of ordinary skill in the art that the invention can be embodied in other specific forms without departing from the spirit or essential character thereof. For example, multiple color wheels or color filters may be positioned at various locations including the output of each light source 204 to filter specific wavelengths and colors of light. Additionally, the color wheels or color filters may also be positioned at the output of the housing 210 to filter the homogenized mixed light 228. Furthermore, positioning of the light sources 204 requires modeling or experimental testing to determine the optimum spacing between the light sources 204. One advantage of the presently disclosed embodiment over that of Bartlett is that the light sources 204 may be placed closer together thereby minimizing the size of the package. Furthermore, the presently disclosed embodiments are not constrained by tilt-sensitive arc lamps. The presently disclosed embodiments are therefore considered in all respects to be illustrative and not restrictive. The scope of the invention is indicated by the appended claims rather than the foregoing description, and all changes that come within the meaning and ranges of equivalents thereof are intended to be embraced therein.

Additionally, the section headings herein are provided for consistency with the suggestions under 37 C.F.R. § 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. An optical device for an optical projection system, comprising:
at least two light sources having first and second optic axes; and
a light refraction element for substantially aligning the first and second optic axes of the two light sources with each other.

2. An optical device according to claim 1, wherein the light refraction element is selected from the group consisting of a prism, a square pyramid, a triangular pyramid, a polygon, a lens, and an optical element with curvatures.

3. An optical device according to claim 1, further comprising an aperture between the two light sources and the light refraction element.

4. An optical device according to claim 3, further comprising at least two reflectors that substantially reclaim any reflected or rejected light from the aperture and reflect them back toward the aperture.

5. An optical device according to claim 1, further comprising a housing for substantially combining and confining the two light sources.

6. An optical device according to claim 5, wherein the housing is a substantially hollow integrating rod comprising an optically reflective material.

7. An optical device according to claim 5, wherein the housing is a substantially solid integrating rod comprising an optical glass material.

8. An optical device according to claim 5, wherein the housing is an integrating rod that is partially hollow and partially solid.

9. A method of manufacturing an optical device for an optical projection system, the method comprising:
providing at least two light sources having first and second optic axes; and
substantially aligning the first and second optic axes of the two light sources with each other with a light refraction element.

10. A method according to claim 9, wherein substantially aligning with a light refraction element comprises the light refraction element being selected from the group consisting of a prism, a square pyramid, a triangular pyramid, a polygon, a lens, and an optical element with curvatures.

11. A method according to claim 9, further comprising substantially reflecting the two light sources into an aperture.

12. A method according to claim 11, wherein substantially reflecting the two light sources into an aperture further comprises at least two reflectors that substantially reclaim any reflected or rejected light from the aperture and reflect them back toward the aperture.

13. A method according to claim 9, wherein substantially aligning the two light sources further comprises substantially combining and confining the two light sources within a housing.

14. A method according to claim 13, wherein the housing for substantially aligning the two light sources is an integrating rod that is substantially hollow and coated with an optically reflective material.

15. An optical projection system, comprising:
an optical device comprising:
at least two light sources having first and second optic axes; and
a light refraction element for substantially aligning the first and second optic axes of the two light sources with each other;
at least one modulator for receiving the substantially aligned beam of light and modulating the substantially aligned beam of light; and
at least one projection lens for focusing the modulated beam of light onto an image plane.

16. A system according to claim 15, wherein the optical device further comprises an aperture between the two light sources and the light refraction element.

17. A system according to claim 16, wherein the optical device further comprising at least two reflectors that substantially reclaim any reflected or rejected light from the aperture and reflect them back toward the aperture.

18. A system according to claim 15, wherein the light refraction element of the optical device is selected from the group consisting of a prism, a square pyramid, a triangular pyramid, a polygon, a lens, and an optical element with curvatures.

19. A system according to claim 15, wherein the optical device further comprises a housing for substantially combining and confining the two light sources.

20. A system according to claim 19, wherein the housing of the optical device comprises an integrating rod that is substantially hollow and coated with an optically reflective material.
